(19) United States
(12) Patent Application Publication
(10) Pub. No.: US 2009/0162641 A1
(43) Pub. Date: Jun. 25, 2009

(54) Coated printing paper

(75) Inventors: Hiroshi Koyamoto, Tokyo (JP); Masashi Okamoto, Tokyo (JP); Koji Okomori, Tokyo (JP); Takashi Ochi, Tokyo (JP)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: NIPPON PAPER INDUSTRIES CO., LTD., Tokyo (JP)

(21) Appl. No.: 12/097,366

(22) PCT Filed: Dec. 14, 2006
(86) PCT No.: PCT/JP2006/324934

§ 371 Date: Jun. 13, 2008

(30) Foreign Application Priority Data
Dec. 14, 2005 (JP) 360765/2005
Apr. 24, 2006 (JP) 119903/2006
Sep. 7, 2006 (JP) 243453/2006

(51) Int. Cl. B32B 5/16

(52) U.S. Cl. 428/328; 977/773

(57) ABSTRACT

The present invention aims to provide coated printing paper having good printing quality combined with the property of decomposing hazardous substances upon exposure to light and resistance to fading.

Coated printing paper comprising a coating layer containing a pigment and an inorganic adhesive and an organic adhesive on a base paper, wherein the coating layer contains 1-30 parts by weight of titanium dioxide having an average secondary particle diameter of 300-2000 nm per 100 parts by weight of the pigment and the coated paper has a PPS roughness of 0.5-5.0 μm.

### TECHNICAL FIELD

The present invention relates to coated printing paper having printing quality and an excellent air-cleaning effect.

### BACKGROUND ART

Titanium dioxide is gaining the spotlight in line with a growing desire to eliminate hazardous substances in everyday life such as offensive odors as an interest in the living environment rises. Titanium dioxide has been conventionally used as a pigment having excellent opacity and brightness for papermaking, and fine particles of titanium dioxide are known to use light energy to induce redox reactions, thereby decomposing various hazardous substances in the air, so that techniques for supporting them on paper are under development in order to apply this phenomenon. For example, a photocatalytic paper incorporating a water-soluble polymer and a material having a photocatalytic effect such as titanium dioxide has been disclosed (see patent document 1), but it cannot be said that the incorporation of a photocatalytic material in paper layers is efficient and sufficiently effective because such a material produces its catalytic effect by exposure to light. Moreover, the resulting color print quality such as ink adhesion, print gloss or print clarity is not sufficient. Printing sheets coated with a coating containing fine powder of titanium dioxide complexed with an inorganic binder such as silica sol and further bound by an organic adhesive have also been disclosed (see patent documents 2 and 3). However, papers coated with a mixed coating of titanium dioxide and silica sol had problems associated with the small particle diameters of titanium dioxide and silica sol, i.e., the coating has low flowability resulting in poor coatability and provides insufficient coverage impairing printing quality known to be important in coated printing papers such as print gloss, print evenness and surface strength. They were also insufficient in shelf life as printing papers because they lost brightness and faded in environments where they were exposed to UV light such as sunlight.

As discussed above, it was difficult to prepare coated printing paper of good printing quality having an excellent air-cleaning effect, low brightness loss and resistance to fading by conventional methods.

### REFERENCES

Patent document 1: JPA HEI-10-226983.

Patent document 2: JPA 2000-129595.

Patent document 3: JPA HEI-11-117196.

### DISCLOSURE OF THE INVENTION

### Problems to be Solved by the Invention

In view of these circumstances, an object of the present invention is to provide coated printing paper having good printing quality combined with the property of decomposing hazardous substances upon exposure to light and resistance to fading.

### Means to Solve the Problems

As a result of careful studies to achieve the above object, we found that a coated printing paper having high print gloss and good print evenness combined with the property of decomposing hazardous substances upon exposure to light, low brightness loss and resistance to fading can be obtained by providing a coated paper comprising a coating layer containing a pigment and an inorganic adhesive and an organic adhesive on a base paper, wherein the coating layer contains 1-30 parts by weight of fine particles of titanium dioxide having an average secondary particle diameter of 300-2000 nm per 100 parts by weight of the pigment and the coated paper has a PPS roughness of 0.5-5.0 μm. Moreover, a good balance between the printing quality such as print gloss, print evenness or surface strength and the photocatalytic effect can be attained by including 5-30 parts by weight of an organic adhesive per 100 parts by weight of the pigment wherein the organic adhesive includes 50% by weight or more of a copolymer latex. The copolymer latex preferably has a glass transition temperature of −20-40° C. In the present invention, the paper is preferably surface-treated with the titanium dioxide mixed with a silica sol or alumina sol in a ratio of 2:1-1:2 to further reduce the deterioration of the paper due to decomposition reaction of the photocatalyst and the deterioration of printing quality due to decomposition of ink components or the like.

### ADVANTAGES OF THE INVENTION

According to the present invention, coated printing paper having good print gloss, print evenness and surface strength combined with the property of decomposing hazardous substances upon exposure to light and resistance to fading can be obtained.

### PREFERRED EMBODIMENTS OF THE INVENTION

In the present invention, it is important that the pigment incorporated in the coating solution partially contains a specific proportion of fine particles of titanium dioxide having photocatalytic properties and an average secondary particle diameter of 300-2000 nm, preferably 500-1500 nm, more preferably 700-1300 nm, in order to confer an air-cleaning effect on the coated printing paper. Titanium dioxide per se has photocatalytic properties irrespective of particle diameter. If the average secondary particle diameter is less than 300 nm, productivity decreases because of low dispersibility of the titanium dioxide slurry and low flowability of the coating, and moreover, printing quality and printability deteriorate because titanium dioxide falls off. If the average secondary particle diameter exceeds 2000 nm, however, the smoothness of the coated paper decreases and therefore, printing quality deteriorates. Titanium dioxide preferably has a primary particle diameter of 5-100 nm, more preferably 10-50 nm. If the primary particle diameter is less than 5 nm, the dispersibility of the titanium dioxide slurry and the flowability of the coating tend to decrease, thus impairing printing quality and printability. If it exceeds 100 nm, photocatalytic properties tend to be insufficient because the surface area decreases.

Fine particles of titanium dioxide can have the property of decomposing hazardous substances in the air upon exposure to light. The proportion is 1-30 parts by weight, preferably 1-20 parts by weight, more preferably 2-10 parts by weight per 100 parts by weight of the pigment. If the proportion of titanium dioxide is less than 1 part by weight, the amount of the photocatalyst is too small to achieve a sufficient air-cleaning effect. In the present invention, it is important to use fine particles of titanium dioxide having a high photocatalytic effect, but fine particles of titanium dioxide have very low flowability so that they form a slurry with very low consistency when they are used in a coating. Therefore, if the proportion exceeds 30 parts by weight, an air-cleaning effect is obtained, but the consistency of the coating extremely decreases so that it becomes difficult to apply at a certain coating mass or more or the resulting paper has poor print evenness, surface strength and chalking resistance when compared at a coating mass used in conventional coated papers. The chalking resistance refers to the resistance to dusting by photodecomposition and deterioration of the coating layer surface and the base paper layer after exposure to light. The titanium dioxide particles in the present invention can be prepared from not only titanium dioxide but also any titanium oxide or hydroxide called hydrous titanium dioxide, hydrated titanium dioxide, metatitanic acid, orthotitanic acid, and titanium hydroxide. The titanium dioxide used in the present invention preferably has a specific surface area of 10-350 m²/g. The titanium dioxide of the present invention can also be mixed with a silica sol or alumina sol so that the fine particles of titanium dioxide are covered with the silica sol or alumina sol having an inorganic adhesive function, thereby reducing the deterioration of the paper due to decomposition reaction of the photocatalyst, improving fade resistance, and further reducing the deterioration of printing quality due to decomposition of ink components or the like. The weight ratio of titanium dioxide and an inorganic adhesive consisting of a silica sol or alumina sol is in the range of 5:1-1:5, preferably 2:1-1:2. In terms of light transmission, a silica sol is preferably used. In order to efficiently cover fine particles of titanium dioxide during the preparation of the coating solution, it is preferably prepared by mixing titanium dioxide and a colloidal silica or alumina solution in certain proportions, and after stirring for a certain period, adding other pigments and additives.

In the present invention, the coating solution can also contain pigments conventionally used for preparing coated papers in addition to the titanium oxide defined above, including inorganic pigments such as precipitated calcium carbonate, ground calcium carbonate, clay, kaolin, engineered kaolin, delaminated clay, talc, calcium sulfate, titanium dioxide used for conventional papermaking, barium sulfate, zinc oxide, silicic acid, silicic acid salts and satin white, or organic pigments such as plastic pigments. In the present invention, it is preferable to use calcium carbonate, especially fine ground calcium carbonate having an average particle diameter of 0.3-2.0 μm, more preferably 0.3-0.8 μm as measured by laser diffraction to improve print evenness, brightness and ink drying properties. Calcium carbonate is preferably contained in an amount of 30 parts by weight or more, more preferably 50 parts by weight or more per 100 parts by weight of the pigment.

The adhesive used in the present invention can be selected as appropriate from one or more of organic adhesives conventionally used for coated paper, e.g., synthetic adhesives such as various copolymer latexes including styrene-butadiene copolymers, styrene-acrylic copolymers, ethylene-vinyl acetate copolymers, butadiene-methyl methacrylate copolymers and vinyl acetate-butyl acrylate copolymers, or polyvinyl alcohols, maleic anhydride copolymers and acrylic-methyl methacrylate copolymers; and water-soluble polymer adhesives including proteins such as casein, soybean protein and synthetic proteins; starches such as oxidized starches, cationized starches, urea phosphate-esterified starches and hydroxyethyl etherified starches; and cellulose derivatives such as carboxymethyl cellulose, hydroxymethyl cellulose and hydroxyethyl cellulose. The organic adhesives are preferably contained at 5-30 parts by weight, more preferably 8-25 parts by weight, still more preferably 8-20 parts by weight per 100 parts by weight of the pigment. More than 30 parts by weight are not preferred because the consistency of the coating decreases to invite productivity problems such as difficulty in controlling the coating mass, high drying load and low coating speed or titanium dioxide is covered by the adhesives, thereby reducing the air-cleaning effect. Less than 5 parts by weight are not preferred because sufficient surface strength cannot be attained. In terms of the air-cleaning effect, the organic adhesives are preferably contained at lower proportions. To achieve a good balance of the printing quality, surface strength and air-cleaning effect, a copolymer latex is contained as an organic adhesive preferably at 50% by weight or more, more preferably 60% by weight or more of the total organic adhesive composition. In the preparation of conventional coated printing papers, latexes and starches are often used in combination. In order to attain a comparable surface strength, more starches must be incorporated than latexes because they each have an approximately equal UV transmittance when compared at a similar coating mass, but starches are inferior to latexes in adhesive force. If the proportion of the latex in the total organic adhesive composition is less than 50%, more starch must be incorporated, whereby the total amount of the organic adhesive composition increases, light transmission decreases, titanium dioxide is covered with the organic adhesives and consequently, the photocatalytic effect decreases. The copolymer latex used preferably has a glass transition temperature of −20-40° C., more preferably −20-30° C., still more preferably 0-30° C. If the glass transition temperature exceeds 40° C., sufficient surface strength to endure printing cannot be attained. If the glass transition temperature is less than −20° C., the photocatalytic effect tends to be insufficient or the runnability tends to decrease due to sticking to rolls or for other reasons. In the case of copolymer latexes having different glass transition temperatures in particles such as core-shell latexes, the shell layer (surface layer) preferably has a glass transition temperature in the range defined above and the core layer (inside layer) preferably has a glass transition temperature lower than that of the shell layer (surface layer). The copolymer latex preferably has a particle diameter of 40-130 nm to ensure printing quality and surface strength. Water-soluble polymer adhesives such as starches are preferably present at 10 parts by weight or less.

The coating solution of the present invention may contain various conventional additives such as dispersants, thickeners, water-retention agents, antifoamers, insolubilizers, dyes, fluorescent dyes, etc.

The base paper in the present invention comprises pulp, fillers and various additives. The pulp can include chemical pulp, mechanical pulp, recycled pulp and the like, but preferably contains 60% by weight or less of mechanical pulp in the total pulp composition, most preferably wholly consists of chemical pulp in terms of printing quality because base papers excessively containing mechanical pulp and recycled pulp derived from mechanical pulp deteriorate and discolor upon exposure to light.

In the present invention, fillers that can be used in the base paper include known fillers such as precipitated calcium carbonate, ground calcium carbonate, talc, kaolin, clay, amorphous silicates, amorphous silica, titanium dioxide, precipitated calcium carbonate-silica complexes and synthetic resin fillers, which are contained in an amount of about 1-30% by weight, preferably 3-20% by weight based on the pulp weight. These fillers can be used alone or as a mixture of two or more of them for the purpose of controlling the suitability of the stock slurry for papermaking or strength characteristics.

The base paper can be prepared from the stock optionally with chemicals conventionally used in papermaking processes, such as paper strength enhancers, sizing agents, antifoamers, colorants, softening agents, bulking agents (density reducing agents) or the like in the range not inhibiting the advantages of the present invention.

The base paper may be prepared by any of acidic, neutral and alkaline processes using, but not limited to, a Fourdrinier machine including a top wire or the like, a cylinder machine or a gap former. The base paper may also be precoated with starch or polyvinyl alcohol using a size press, gate roll coater, bill blade or the like. The basis weight of the base paper is not specifically limited for use in conventional coated papers and coated paperboards. In the case of typical coated papers, the basis weight is about 25-200 g/m², more preferably 50-150 g/m². In the case of coated paperboards, the basis weight is about 230-600 g/m², more preferably 250-500 g/m².

The coating solution prepared is applied in one or more layers on one or both sides of the base paper using a blade coater, bar coater, roll coater, air knife coater, reverse roll coater, curtain coater, size press coater, gate roll coater or the like. The range of the coating mass in the present invention is not specifically limited, but preferably 4 g/m² or more and 40 g/m² or less, more preferably 10 g/m² or more and 35 g/m² or less, still more preferably 10 g/m² or more and 30 g/m² or less per side to achieve a better balance of the printing quality, photocatalytic effect and coatability. When the photocatalyst titanium dioxide is contained in the coating layer in the present invention, the titanium dioxide distributed in upper parts of the coating layer is effective to produce a photocatalytic effect. Thus, coated printing papers having a photocatalytic effect and improved printing quality, surface strength and the like can be obtained in the present invention by providing two or more coating layers, among which the outermost coating layer contains the titanium dioxide defined above and one or more inner layers are prepared separately from the outermost layer. In this case, the coating containing the photocatalyst titanium dioxide is preferably applied on the outermost layer at 2 g/m² or more and 20 g/m² or less, more preferably 3 g/m² or more and 15 g/m² or less, still more preferably 5 g/m² or more and 15 g/m² or less.

The wet coating layer is dried by using a conventional means such as, e.g., a steam heater, gas heater, infrared heater, electric heater, hot air dryer, microwave, cylinder dryer, etc.

After drying, the paper can be optionally post-processed to confer smoothness by a finishing process using a supercalender, hot soft nip calender or the like, and it can be processed by any type of calender or uncalendered so far as a coated paper of a desired quality can be obtained. However, calendering gives a dense structure to the coating layer to further increase smoothness, which in turn reduces the area in contact with the air and thus tends to reduce the probability that the photocatalyst in the coating layer comes into contact with hazardous components in the air, thereby reducing the air-cleaning effect. Thus, the paper in the present invention is preferably calendered at a linear pressure of 250 kN/m or less, more preferably weakly calendered at 150 kN/m or less, still more preferably uncalendered.

In the present invention, it is important that the PPS roughness is in the range of 0.5-5.0 μm to provide good printing quality and a photocatalytic function. The printing inks used include inks for sheet-fed offset printing (lithography), inks for rotary offset printing, inks for gravure printing, etc., and more suitably exclude newsprint inks. If the PPS roughness exceeds 5.0 μm, ink adhesion during printing deteriorates to impair print evenness and print gloss because of poor smoothness. If the PPS roughness is low, smoothness increases but the structure of the coating layer becomes dense, which in turn reduces the surface area in contact with the air and thus reduces the probability that the photocatalyst in the coating layer comes into contact with hazardous components in the air, thereby reducing the air-cleaning effect. In order to promote the photocatalytic effect and to improve printing quality and the like, the PPS roughness is preferably 1.0-4.0 μm, more preferably 2.0-4.0 μm. The PPS roughness can be controlled by the calendering conditions, pulp composition, coating composition, coating mass, etc.

### EXAMPLES

The following examples further illustrate the present invention without, however, limiting the invention thereto as a matter of course. Unless otherwise specified, parts and % in the examples mean parts by weight and % by weight, respectively. Coating solutions and the resulting coated printing papers were tested by the following evaluation methods.

### (Evaluation Methods)

(1) Particle size analysis of titanium dioxide: calculated from electron micrographs.

A thin layer of a slurry of fine particles of titanium dioxide was applied on a sample mount for electron microscopy and dried in a dryer set at 40° C. Then, microphotographs of the particles were taken with 10000× magnification using FE-SEM (Field Emission Scanning Electron Microscope/JSM-6700F available from JEOL Ltd.) and observed and analyzed. As for secondary particles, the diameters of 100 particles were measured to calculate an average secondary particle diameter.

(2) PPS roughness: determined according to ISO8791/4 at a clamp pressure of 1000 kPa using a hard backing having a hardness of 95IRHD.

(3) Print gloss: determined according to JIS P 8142 on the surface of a print (solid in 4 colors) printed by a Roland sheet offset press (4-color) using sheet offset inks (Hy-Unity L available from Toyo Ink Mfg. Co., Ltd.) at a printing speed of 8000 sheets/hr.

(4) Print evenness: visually evaluated according to the 4-class scale below for the evenness of ink adhesion and the evenness of print gloss of a print (solid in 4 colors) printed by a Roland sheet offset press (4-color) using sheet offset inks (Hy-Unity L available from Toyo Ink Mfg. Co., Ltd.) at a printing speed of 8000 sheets/hr: ⊚: very good, ∘: good, Δ: slightly poor, x: poor.

(5) Surface strength: visually evaluated according to the 4-class scale below by comparing dry pick strength in an RI-II print tester using SMX tack grade 16 (black) ink available from Toyo Ink Mfg. Co., Ltd.: ⊚: very good, ∘: good, Δ: slightly poor, x: poor.

(6) Chalking resistance (dusting after exposure to light): After UV irradiation with black light at an intensity of 2.5 mW/cm² for 5 hours, an adhesive cellophane tape was applied on the surface of the coated paper and then slowly removed and the resistance to transfer to the adhesive cellophane tape was visually evaluated according to the 4-class scale below: ⊚: very good, ∘: good, Δ: slightly poor, x: poor.

(7) Photocatalytic effect: evaluated by the photocatalyst performance evaluation test method II b “gas bag B-method”. The degree of acetaldehyde decomposition (%) was determined after UV irradiation for 20 hours and evaluated according to the 4-class scale below: ⊚: very good (decomposition degree: 99% or more), ∘: good (99-50%), Δ: slightly poor (49%-10%), x: significantly poor (10% or less).

(8) Fade test: evaluated from the loss of ISO brightness determined before and 24 hours after UV irradiation (samples were irradiated with black light at an intensity of 2.5 mW/cm²).

Loss of brightness(%)=(brightness before UV irradiation−

brightness after UV irradiation)/brightness before UV

irradiation×100.

### Example 1

### Preparation of a Top Coating Solution

In a Cellier mixer, 5 parts (solids) of a slurry of fine particles of titanium dioxide (CSB-M available from Sakai Chemical Industry, Co., Ltd.; primary particle diameter 20-30 nm, average secondary particle diameter 1000 nm) and 8 parts of colloidal silica (Snowtex 40 available from Nissan Chemical Industries, Ltd.) were stirred for 1 hr. Into this mixed slurry was added a pigment slurry prepared from a pigment comprising 60 parts of ground calcium carbonate (FMT-90 available from Fimatec Ltd.) and 35 parts of secondary clay (KCS available from Imerys) dispersed with sodium polyacrylate (0.2 parts based on the inorganic pigment) in a Cellier mixer to prepare a pigment slurry having a solids content of 71%. To the pigment slurry thus obtained were added 13 parts of styrene-butadiene copolymer latex A (glass transition temperature 0° C., particle diameter 100 nm), 5 parts of hydroxyethyl-etherified starch (PG295 available from Penford Corporation) and water to give a coating solution having a solids content of 63%.

<Preparation of a Pre-Coating Solution>

To a pigment slurry comprising 100 parts of ground calcium carbonate (FMT-90 available from Fimatec Ltd.) were added 6 parts of styrene-butadiene copolymer latex A, 5 parts of hydroxyethyl-etherified starch (PG295 available from Penford Corporation) and water to give a prime coating solution having a solids content of 68%.

The base paper to be coated was a woodfree paper having a basis weight of 120 g/m² and containing 12% of precipitated calcium carbonate based on the weight of the base paper as filler and 100% of chemical pulp as papermaking pulp.

The pre-coating solution was applied on both sides of the base paper at a coating mass of 8 g/m² per side using a blade coater at a coating speed of 500 m/min. Then, the top coating solution was applied on both sides at a coating mass of 8 g/m² per side using a blade coater at a coating speed of 500 m/min and dried to a moisture content of 5% in coated paper to give a coated printing paper.

### Example 2

A coated printing paper was obtained by the same procedure as in Example 1 except that 5 parts (solids) of the slurry of fine particles of titanium dioxide, 8 parts of colloidal silica, 60 parts of ground calcium carbonate, and 35 parts of secondary clay in the top coating solution were replaced by 20 parts (solids) of the slurry of fine particles of titanium dioxide, 32 parts of colloidal silica, 55 parts of ground calcium carbonate, and 25 parts of second grade clay.

### Example 3

A coated printing paper was obtained by the same procedure as in Example 1 except that 13 parts of latex A and 5 parts of starch in the top coating solution were replaced by 9 parts of latex A and 13 parts of starch.

### Example 4

A coated printing paper was obtained by the same procedure as in Example 1 except that latex A in the top coating solution was replaced by styrene-butadiene copolymer latex B (glass transition temperature 45° C., particle diameter 110 nm).

### Example 5

A coated printing paper was obtained by the same procedure as in Example 1 except that only the top coating solution described in Example 1 was applied at 16 g/m² on the base paper.

### Example 6

A coated printing paper was obtained by the same procedure as in Example 1 except that the coated paper was dried and then the coated paper was treated in a hot soft nip calender with 2 nips at a metal roll surface temperature of 100° C., a paper feed speed of 700 m/min, and a linear pressure of 140 kN/m.

### Example 7

A coated paperboard was obtained by the same procedure as in Example 1 except that a white paperboard having a basis weight of 328 g/m² was used as a base paper in place of the woodfree paper having a basis weight of 120 g/m².

### Example 8

A coated printing paper was obtained by the same procedure as in Example 1 except that 5 parts (solids) of the slurry of fine particles of titanium dioxide, 8 parts of colloidal silica, 60 parts of ground calcium carbonate, and 35 parts of second grade clay in the top coating solution were replaced by 5 parts (solids) of the slurry of fine particles of titanium dioxide, 8 parts of colloidal silica, 75 parts of fine-grained clay (Amazon plus available from CADAM), and 20 parts of fine ground calcium carbonate (FMT-97 available from Fimatec Ltd.) and the coated paper was treated in a hot soft nip calender with 6 nips at a metal roll surface temperature of 160° C., a paper feed speed of 500 m/min, and a linear pressure of 220 kN/m.

### Comparative Example 1

A coated printing paper was obtained by the same procedure as in Example 1 except that 5 parts (solids) of the slurry of fine particles of titanium dioxide, 8 parts of colloidal silica, 60 parts of ground calcium carbonate, and 35 parts of secondary clay in the top coating solution were replaced by 65 parts of ground calcium carbonate and 35 parts of second grade clay.

### Comparative example 2

A coated printing paper was obtained by the same procedure as in Example 1 except that 5 parts (solids) of the slurry of fine particles of titanium dioxide, 8 parts of colloidal silica, 60 parts of ground calcium carbonate, and 35 parts of second grade clay in the top coating solution were replaced by 40 parts (solids) of the slurry of fine particles of titanium dioxide, 64 parts of colloidal silica, 40 parts by weight of ground calcium carbonate, and 20 parts by weight of secondary clay.

### Comparative Example 3

A coated printing paper was obtained by the same procedure as in Example 1 except that only the top coating solution described in Example 1 was applied at 3 g/m² on the base paper.

### Comparative Example 4

A coated printing paper was obtained by the same procedure as in Example 1 except that 5 parts (solids) of the slurry of fine particles of titanium dioxide, 8 parts of colloidal silica, 60 parts of ground calcium carbonate, and 35 parts of second grade clay in the top coating solution were replaced by 5 parts (solids) of the slurry of fine particles of titanium dioxide, 8 parts of colloidal silica, 75 parts of fine-grained clay (Amazon plus available from CADAM), and 20 parts of fine ground calcium carbonate (FMT-97 available from Fimatec Ltd.) and the coated paper was treated in a hot soft nip calender with 8 nips at a metal roll surface temperature of 160° C., a paper feed speed of 500 m/min, and a linear pressure of 300 kN/m.

The results are shown in Table 1.

TABLE 1

| | PPS | Print | Print | Surface | Chalking | Photocatalytic | Fade test: |
|---|---|---|---|---|---|---|---|
| | roughness | gloss | evenness | strength | resistance | effect | brightness loss (%) |
| Example 1 | 3.2 | 68 | ⊚ | ⊚ | ⊚ | ⊚ | 4.0 |
| Example 2 | 3.5 | 60 | ◯ | ⊚ | ◯ | ⊚ | 1.2 |
| Example 3 | 3.8 | 62 | ◯ | ⊚ | ◯ | ◯ | 4.4 |
| Example 4 | 3.6 | 66 | ⊚ | Δ | ◯ | ◯ | 4.3 |
| Example 5 | 4.0 | 62 | ◯ | ◯ | ⊚ | ⊚ | 2.9 |
| Example 6 | 1.8 | 77 | ⊚ | ⊚ | ⊚ | ◯ | 4.4 |
| Example 7 | 3.4 | 67 | ⊚ | ⊚ | ⊚ | ⊚ | 4.0 |
| Example 8 | 0.7 | 82 | ⊚ | ⊚ | ⊚ | ◯ | 4.0 |
| Comparative | 2.5 | 70 | ⊚ | ⊚ | ⊚ | X | 9.0 |
| example 1 | | | | | | | |
| Comparative | 3.9 | 40 | Δ | Δ | Δ | ⊚ | 0.9 |
| example 2 | | | | | | | |
| Comparative | 5.4 | 35 | Δ | Δ | ⊚ | ◯ | 5.7 |
| example 3 | | | | | | | |
| Comparative | 0.4 | 90 | ⊚ | ◯ | ⊚ | Δ | 4.1 |
| example 4 | | | | | | | |

In Examples 1-8, coated printing papers having good printing quality such as print gloss, print evenness and surface strength combined with the property of decomposing hazardous substances upon exposure to light and resistance to fading can be obtained. Comparative example 1 is poor in photocatalytic effect and fade-resistance. Comparative example 2 is poor in printing quality and chalking resistance. Comparative example 3 is poor in printing quality. Comparative example 4 is poor in photocatalytic effect.

1. A coated printing paper comprising a coating layer containing a pigment and an adhesive on a base paper, characterized in that the coating layer contains 1-30 parts by weight of titanium dioxide having an average secondary particle diameter of 300-2000 nm per 100 parts by weight of the pigment and that the coated paper has a PPS roughness of 0.5-5.0 μm.

2. The coated printing paper of claim 1, characterized in that the coating layer contains 5-30 parts by weight of an organic adhesive per 100 parts by weight of the pigment and that the organic adhesive comprises 50% by weight or more of a copolymer latex.

3. The coated printing paper of claim 2, characterized in that the copolymer latex has a glass transition temperature of −20-40° C.

4. The coated printing paper of claim 1, characterized in that the titanium dioxide is premixed with a silica sol or alumina sol in a ratio of 2:1-1:2.

5. The coated printing paper of claim 1, characterized in that the titanium dioxide has a primary particle diameter of 5-100 nm.

6. The coated printing paper of claim 1, characterized in that it comprises an outermost coating layer containing 1-30 parts by weight of titanium dioxide having an average secondary particle diameter of 300-2000 nm per 100 parts by weight of the pigment and one or more inner coating layers adjacent to the outermost layer.

7. The coated printing paper of claim 1, characterized in that the coated paper has been calendered at a linear pressure of 250 kN/m or less or has not been calendered.
